(19) United States
(12) Patent Application Publication
(10) Pub. No.: US 2011/0291570 A1
(43) Pub. Date: Dec. 1, 2011

(54) Energy-Efficient Luminaire with Automatic Multilevel Illumination

(76) Inventors: Saman Sinai, Los Angeles, CA (US); Benjamin Pouladian, Los Angeles, CA (US)

(21) Appl. No.: 12/791,846

(22) Filed: Jun. 1, 2010

(51) Int. Cl. H05B 37/02; H01J 9/00

(52) U.S. Cl. 315/149; 315/307; 445/23; 445/26

(57) ABSTRACT

One embodiment of an energy-efficient light fixture with automatic multilevel illumination comprising a housing that contains multiple ballasts and multiple lamps at least one of which is controlled by an occupancy sensor. At least one of the lamps remains on constantly to provide security in structures which would benefit from the safety that constant illumination provides. The other lamps will remain off until occupancy is detected from a sensor located within the luminaire housing and connected to one of the ballasts located therein.

### BACKGROUND

### Prior Art

The following is a tabulation of some prior art that presently appears relevant:

### U.S. Patents

| U.S. Pat. No. | Kind Code | Issue Date | Patentee |
|---|---|---|---|
| 5,489,827 | | Feb. 6, 1996 | Xia |
| 4,104,711 | | Aug. 1, 1978 | Carter |
| 7,081,715 | B1 | Jul. 25, 2006 | Goldstein |
| 7,271,543 | B1 | Sep. 18, 2007 | Goldstein |

### U.S. Patent Application Publications

| Publication Number | Kind Code | Publ. Date | Applicant |
|---|---|---|---|
| None found | | | |

### Foreign Patent Document

None found

### Nonpatent Literature Documents

None found

Parking garages and other structures requiring continuous illumination for safety commonly pair lighting fixtures with occupancy sensing devices. This combination conserves energy by allowing the lights remain off when structures are vacant and then turning on briefly when a person or vehicle is detected. Such conventional setups are used to conserve energy when illumination is not needed while maintaining a nominal degree of security when the structures become occupied at night.

These conventional fixtures often use high intensity discharge (HID) lamps or fluorescent lamps which can consume significantly more energy than more modern lamps. Furthermore, these lamps have a significantly shorter service life than their modern counterparts. An incandescent lamp or conventional fluorescent lamp has an electrode inside the glass bulb. These connections reduce the service life of such lamps by as much as a factor of ten when compared to modern lamps without electrodes.

The occupancy sensor that activates these lights in a conventional set up is connected to multiple lamps and is not integral to any single luminaire. Accordingly, when the device detects the presence of an individual all of the lamps connected to that device will then be turned on. If no one is detected, then all of the lamps will remain off. The conventional setup does not provide for nominal illumination when the structure is unoccupied. The lights are either all on or all off. This creates a risk to a pedestrians who enter the structure without knowing someone else may be hiding in the dark.

Furthermore, a common characteristic of the conventional setup is that all of the lamps within a given fixture are the same wattage. If the luminaire contains multiple lamps, they do not operate independent of one another. All of the lamps contained in each individual fixture are all on at once or off at once. The prior art does not teach a luminaire which contains multiple energy efficient lamps one of which remains on continuously while the others are activated using an integral occupancy sensing means.

In a conventional setup where HID lamps are commonly used, the user is required to keep these inefficient lamps on all of the time. They cannot be paired to occupancy sensors because of the large restrike times associated with these types of lamps which may be as long as fifteen minutes. It is common in the art to use 150 watt HID lamps in order to meet the minimum footcandle requirements of the Illuminating Engineering Society (IES).

These conventional sensor lamp setups are costly as they can only be achieved using lighting control systems comprised of ballasts, wiring, and separate, externally located occupancy sensors. Having this many components not integral with the luminaries creates additional expense in installation, design and maintenance costs. The independent sensor means that wiring will have to be run from it to a proximate luminaire. Other, more complex means may also be devised to accomplish this intention. Consumers have objected to the exorbitant cost and minimal security that these setups provide.

Because these conventional setups are comprised of lamps which are either entirely on or entirely off, pedestrians are vulnerable when such fixtures are utilized in unsecured areas such as parking garages, warehouses, correctional facilities, factories, transportation facilities, security areas, and other installations where continuous illumination is required for safety, and full illumination is needed only when the space occupied by people or vehicles.

For example, a parking garage at night is a particularly unsafe environment when not lit properly. If the lights in the parking garage are not kept on constantly it is foreseeable that someone may hide in the shadows and sneak up on an unsuspecting pedestrian. That person will have been able to hide because of flaws in the conventional setup. The way these systems operate is by turning on for a preset duration only when an occupant or vehicle is detected. Once a preset duration of time has elapsed the lights promptly turn off creating an opportunity for someone who had just entered to hide in the dark and wait for the arrival of someone else who doesn't expect them. This risk was offset by the exorbitant costs associated with keeping the lights on at all hours of the night. This was beneficial with lamps that consumed so much power as HIDs or fluorescent lamps but today this benefit does not outweigh the cost.

An added problem with the fixtures currently in use is that one motion sensor is connected to multiple light fixtures. As a result, when the sensor picks up movement there is no specificity as to the area which is illuminated. What this means, is that energy is being consumed to illuminate areas unnecessarily.

Several types of motion activated lighting systems have been proposed however all of the systems heretofore known suffer from a number of disadvantages:
(a) Exorbitant cost associated with designing an automatic illumination system with an occupancy sensor that is not integrated with the luminaire(s) it activates.
(b) The excessive cost of maintaining such a system.
(c) Wasted electricity because conventional automatic illumination systems pair a single occupancy sensor to multiple lamps resulting in activation of superfluous lamps illuminating areas unoccupied by vehicles or pedestrians.
(d) Inefficient use of electricity associated with HID and florescent lamps.
(e) Lack of security caused by the systems not having a single lamp that remains on continuously even when the building it is in is unoccupied.
(f) Conventional HID lamps cannot be coupled to occupancy sensors due to restrike times of up to 15 mins.

### SUMMARY

In accordance with one embodiment a luminaire comprises a plurality of lamps one of which remains on constantly while the others may be activated automatically through the use of an integral occupancy-sensing device.

### ADVANTAGES

Thus several advantages of one or more aspects are to provide a more energy efficient multilevel electrodeless luminaire with an integral occupancy sensor. These and other advantages of one or more aspects will become apparent from the consideration of the ensuing description and accompanying advantages.

A luminaire with an integral occupancy sensor and multiple lamps allows for use in a wide variety of places. These types of applications include, but are not limited to, parking garages, warehouses, correctional facilities, factories, transportation facilities, security areas, and other installations where continuous illumination is required for safety, and full illumination is needed only when the space occupied by people or vehicles. With typically low occupancy areas vacant up to 98% of the time, one embodiment of an energy-efficient light fixture with automatic multilevel illumination provides maximum utility energy savings for the end-user without the risks associated with conventional lamp-sensor setups because it contains one energy efficient lamp that remains on all of the time.

Induction lamp technology operates by using mercury vapor in a glass bulb that is electrically excited to produce shortwave ultraviolet light, which then excites the phosphorous to produce visible light. The lamp does not contain an electrode and can be turned on instantaneously allowing them to be paired to an occupancy sensor. HID lamps cannot because of the long restrike time associated with such lamps. Moreover, electrodes are the primary factor resulting in the short service life of conventional light fixtures. The fact that induction lamps do not contain electrodes means that there service life is significantly higher than that of a conventional lamp.

Furthermore, luminaire allows each fixture to be operated independent from one another. Multiple lamps need not be activated because a single occupancy sensor detects movement. This means more energy savings for the end user.

Accordingly several advantages of one or more aspects are as follows: to provide a luminaire with the motion sensing device contained along with a plurality of lamps, one of which remains on constantly, while the others are activated using an occupancy detecting device. This fixture results in energy savings and enhances safety. Other advantages of one or more aspects will be apparent from a consideration of the drawings and the ensuing description.

The description of the invention which follows, together with the accompanying drawings should not be construed as limiting the invention to the example shown and described, because those skilled in the art to which this invention pertains will be able to devise other forms thereof within the ambit of the appended claims.

### DRAWINGS

### Figures

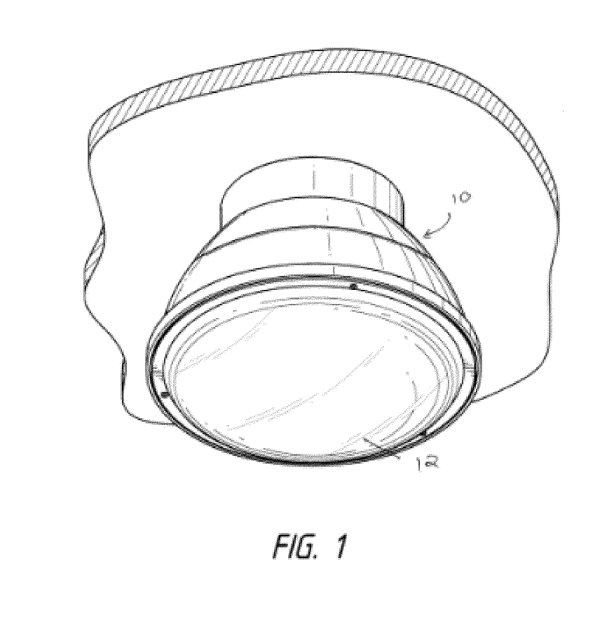

FIG. 1 shows a bottom front perspective view of a luminaire;

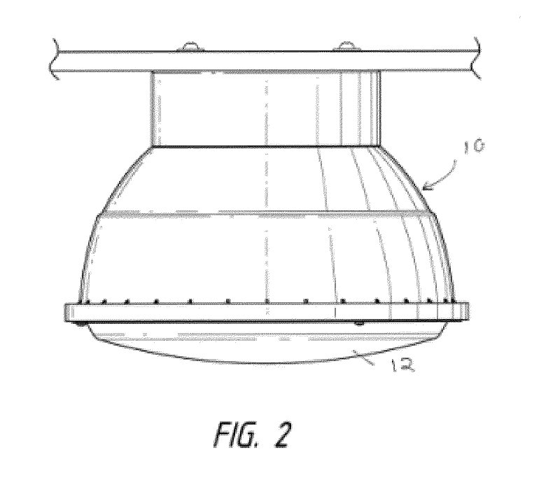

FIG. 2 shows a right side elevation view thereof;

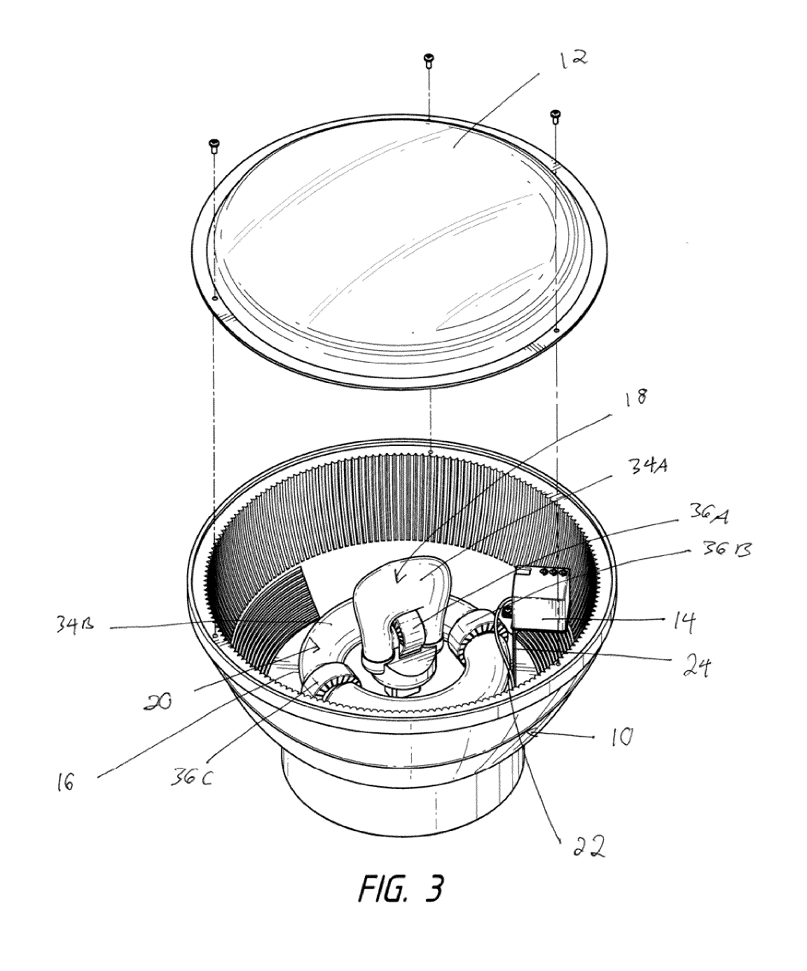

FIG. 3 shows a three-dimensional exploded view of the luminaire shown in FIG. 1;

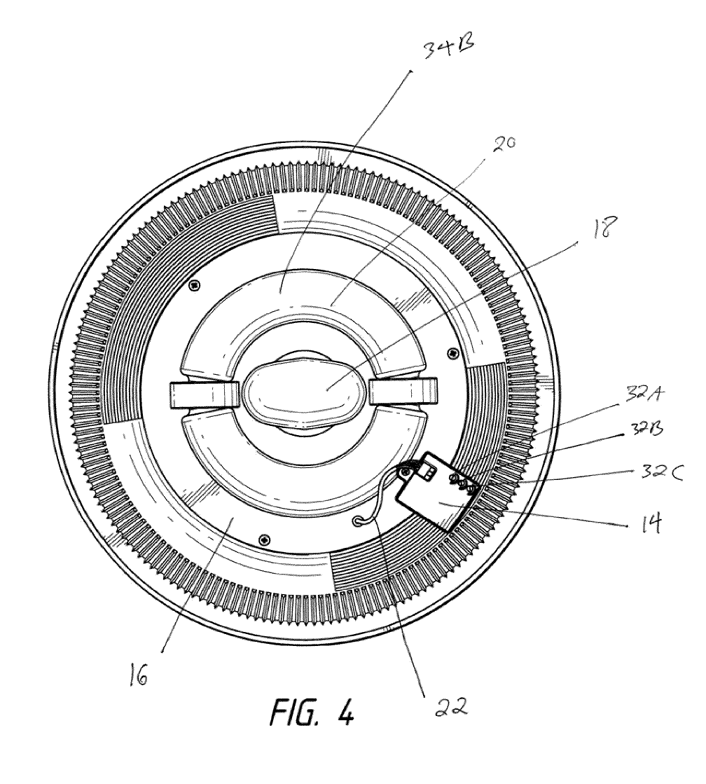

FIG. 4 shows a front elevation view of the luminaire shown in FIG. 1 with the cover removed to exhibit the occupancy sensor and lamps contained therein; and

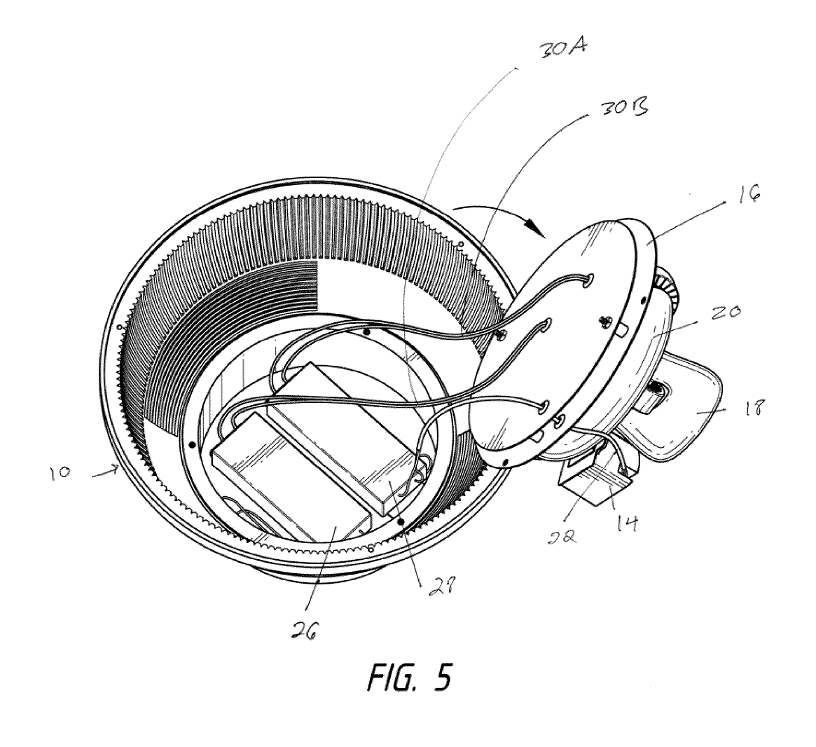

FIG. 5 shows a top front perspective view of the luminaire shown in FIG. 1 with the base plate of the fixture removed to exhibit the drivers beneath.

Drawings - Reference Numerals

| | | | |
|---|---|---|---|
| 10 | luminaire housing | 12 | lens |
| 14 | occupancy sensor | 16 | base plate |
| 18 | lower wattage lamp | 20 | higher wattage lamp |
| 22 | electrical wire | 24 | sensor stand |
| 26 | lower wattage ballast | 28 | higher wattage ballast |
| 30A | high voltage wire | 30B | high voltage wire |
| 32A | rotary member | 32B | rotary member |
| 32C | rotary member | 34A | arc tube |
| 34B | arc tube | 36A | excitation coil |
| 36B | excitation coil | 36C | excitation coil |

### DETAILED DESCRIPTION

One embodiment of the luminaire with automatic multilevel illumination is illustrated in FIG. 1 (bottom front review) and FIG. 2 (right side elevation view). The fixture has a housing 10 which is attached to a lens 12.

For the sake of illustration, only two lamps 18 and 20 are shown in the drawing. This housing luminaire 10 may contain multiple lamps, it being understood that a larger number of lamps (e.g. as many as 10 lamps) may be contained within the luminaire housing 10. One of these lamps is lower wattage 18 and the other one is higher wattage 20. The lower wattage lamp 18 is designed to remain on constantly. However, the higher wattage lamp 20 is controlled by a programmable occupancy sensor 14 which is contained within the housing 10 and sits on a stand 24.

A single power source provides electricity to the luminaire. Each lamp within the housing luminaire 10 is connected to and driven by a ballast. The lower wattage lamp 18 is connected to lower wattage ballast 26 via a high voltage wire 30A. The higher wattage lamp 20 is connected to higher wattage ballast 28 via a high voltage wire 30B. The higher wattage ballast 28 is also connected to an occupancy sensor 14 via an electrical wire 22.

The occupancy sensor 14 is attached to the stand 24. The stand 24 is operative to keep the occupancy sensor 14 from coming in contact with the lamps 18 and 20. The stand 24 is affixed to a baseplate 16 on one end and to the occupancy sensor on the other. The base plate 16 may also act as a heat sink.

The respective levels of light provided by the lamps 18 and 20 are controlled by the respective outputs of ballasts 26 and 28. At least one ballast 28 operates under the control of the programmable occupancy sensor 14. This occupancy sensor 14 is connected to the ballast 28 that drives the higher wattage lamp 20. Whenever a given structure is unoccupied, the higher wattage lamp 20 remains off even though the lower wattage lamp 18 is continually providing illumination.

An example of such an occupancy sensor is the Wattstopper FM—105 Line Voltage High Frequency Occupancy Sensor (Wattstopper) which is hereby incorporated by reference. The occupancy sensor is a 120/270 VAC, 50/60 Hz electrical device measuring 2″ long×3″ wide×1.6″ deep. The sensor is installed and wired in each multilevel luminaire housing 10. It detects movement in the coverage area by producing electromagnetic waves and analyzing changes in reflected waves by the Doppler principle.

This particular occupancy sensor automatically turns the higher wattage lamp 20 on and off based on occupancy. It detects motion via a super high frequency (SHF) electromagnetic waves. Because it can detect motion through many dense materials other than metal, the sensor can be installed in the luminaire housing 10 and hidden from view. When motion is detected, the sensor 14 turns on the load 28, unless the ambient light level is greater than the preset daylight setpoint on the occupancy sensor 14.

The programmable occupancy sensor 14 comprises several rotary members 32A, 32B, and 32C whose physical position determines time delay in holding off the higher wattage ballast 28, the sensitivity and range of the occupancy sensor 14, and the light level setpoint. This setpoint can be controlled using a rotary member located on the outer surface of the device. An example of such a rotary member 32A is depicted in FIG. 4. The occupancy sensor 14 deactivates the load when no motion is detected for the preset duration of time. This amount of time can be controlled by another rotary member located on the outer surface of the device. An example of one such rotary member 32B is depicted in FIG. 4.

The sensor 14 coverage pattern is omnidirectional. Depending on its installation, the Wattstopper can be adjusted to detect occupancy up to 20 feet away. Its integrated daylight sensitivity adjust from 2 to 200 foot candles and it's time delay may be set from 10 seconds to 30 minutes.

A known inductively-driven high-intensity electrodeless discharge lamp comprises an arc tube 34A and 34B having a wall of light-transmissive material. An excitation coil 36A, 36B, and 36C surrounds a portion of the arc tube and is energizable with radiofrequency current to develop a toroidal arc discharge within the arc tube. Energy is transferred through the glass envelope solely by electromagnetic induction.

At least one ballast 26 continually drives a lower wattage lamp 18. This ballast 26 keeps the lower wattage lamp 18 on throughout the day and the night. In one embodiment, the lower wattage lamp 18 is a twenty-three watt electrodeless discharge lamp while the higher wattage lamp may be a forty, sixty, or eighty-watt electrodeless discharge lamp.

In one embodiment both lamps 18 and 20 may be electrodeless discharge lamps. Three different design induction lamps are available. Bulb-shaped induction lamps use an antenna called the power coupler, which consists of a coil wound over a tubular ferrite core. In another configuration the lamp consists of two long parallel glass tubes, connected by two short tubes that have coils mounted around them. A third design is a single ring-shaped tube. The antenna coils receive electric power from an electronic ballast 26 and 28 that generates a high frequency. The exact frequency varies with lamp design, but popular examples include 13.6 MHz, 2.65 MHz and 250 kHz. A special resonant circuit in the ballast produces an initial high voltage on the coil 36A, 36B, and 36C to start a gas discharge; thereafter the voltage is reduced to normal running level. The system can be seen as a type of transformer, with the power coupler forming the primary coil and the gas discharge arc in the bulb forming that one-turn secondary coil and the load of the transformer. The ballast is connected to main electricity, and is generally designed to operate on voltages between 100 and 277 VAC at a frequency of 50 or 60 Hz. In other conventional gas discharge lamps, electrodes are the part with the shortest life, limiting the lamp life span severely. Since an induction lamp has no electrodes, it can have a very long service life. For induction lamp systems with a separate ballast, the service life can be as long as a 100,000 hours which is 11.4 years of continuous operation or 22.8 years when used at night or day only. Typically operations and maintenance costs are significantly lower with induction lighting systems due to their industry average 100,000 hour life cycle and ten-year warranty.

In another embodiment, the higher wattage ballast 28 may be connected to a series of light emitting diode (LED) boards. In this embodiment, the lower wattage ballast 26 would be connected to either an electrodeless discharge lamp or LED board that remains on continuously. Once the integral occupancy sensor 14 detects the presence of a person or a vehicle, it will send an electrical signal via electrical wire 22 to the high output ballast 28 causing the higher wattage lamp 20 (in this case an LED board) to become active.

The noteworthy conservation of energy contemplates use of the lower wattage lamp 18 when the given structure is unoccupied and a higher wattage lamp 20 together with the lower wattage lamp 18 when the occupancy sensor 14 detects the presence of an individual. Once the occupancy sensor 14 detects the presence of an individual, then both the lower wattage lamp 18 and the higher wattage lamp 20 are operational simultaneously.

### ADVANTAGES

The reader will see that the energy-efficient luminaire with automatic multilevel illumination can be used to save energy by activating lamps specifically where illumination is needed without turning on lamps in areas where it is not. Furthermore, using electrodeless discharge lamp technology leads to energy and cost savings for the end user because such lamps are more energy efficient and have longer service lives than those used in conventional lamp-occupancy sensor setups. Moreover, the use of an occupancy sensor which is integral to the luminaire saves in design and maintenance costs when compared with the conventional setup.

From the description above, a number of advantages of some embodiments of our energy-efficient luminaire with automatic multilevel illumination become evident:
(a) Obviate the labor and expense associated with designing complex systems where a motion sensor is disjoined from the luminaire.
(b) Provide for a more energy efficient means of automatic illumination because every lamp has its own occupancy sensor.
(c) Obviate the expense associated with maintaining complex illumination systems where the motion sensor is disjoined from the luminaire.
(d) Provide security and energy efficiency by using modern lamp technology in a luminaire with one energy efficient lamp providing constant illumination.
(e) Energy efficiency associated with having a second high output lamp which is active only when a person or vehicle is detected and then turns off once a preset amount of time has expired.
(f) Using a fully integrated luminaire comprised of multiple lamps and an integral motion sensor allows individual fixtures to be activated independent of one another minimizing the amount of superfluous energy which is wasted by conventional light-sensor setups.
(g) Using induction lamp technology allows for a luminaire that can be paired with an occupancy sensor which controls the lamp and makes it turn on as soon as a person or a vehicle is detected. HID lamps do not allow for this function because of the long restrike time associated with such lamps.
(h) In order to meet IES footcandel requirements in a typical parking lot structure where HID lamps are being used to provide illumination, 150 watt lamps are being used. The input wattage of a 150 watt HID lamp is typically 170 watts while input wattage of a 20 watt electrodeless discharge lamp is typically close to 23 watts. This means 85% less energy is being consumed when the occupancy sensor does not detect and individual or vehicle in the given structure.
(i) In one example, the total combined system watts while both lamps of the automatic electrodeless discharge lamp is 80 watts when the larger electrodeless discharge lamp is a 60 watt lamp and the smaller lamp is 20 watts. This combination can be used to replace a 150 watt HID high pressure sodium (HPS) lamp while still being 50% more energy efficient.

### CONCLUSIONS, RAMIFICATIONS, AND SCOPE

Although the description above contains many specificities, these should not be construed as limiting the scope of the embodiments but as merely providing illustrations of some of several embodiments. For example, the luminaire housing can have more than two lamps and more than two ballasts, and the large lamp may be an electrodeless discharge lamp or an LED lamp.

Thus the scope of the embodiment should be determined by the appended claims and their legal equivalents, rather than by the examples given.

We claim:

1. A multilevel electrodeless luminaire comprising:
a power supply;
a low output lamp which remains on continuously;
an integral occupancy sensing means;
at least one high output lamp which remains off until a person or vehicle is detected by said occupancy sensing means;
a low output driver means to activate said low output lamp; and
at least one high output driver means to activate said high output lamp said high output driver means being connected to said occupancy sensing means which is operative to activate said high output driving means.

2. The multilevel electrodeless luminaire of claim 1 wherein the occupancy sensing means is motion detector.

3. The multilevel electrodeless luminaire of claim 1 wherein the occupancy sensing means stops load from turning on the if ambient light is greater than the daylight setpoint.

4. The multilevel electrodeless luminaire of claim 1 wherein the occupancy sensing means detects motion via super high-frequency electromagnetic waves and the Doppler principle.

5. The multilevel electrodeless luminaire of claim 4 wherein the occupancy sensing means is omnidirectional.

6. The multilevel electrodeless luminaire of claim 1 wherein the low output lamp is an electrodeless discharge lamp.

7. The multilevel electrodeless luminaire of claim 6 wherein the high output lamp is an electrodeless discharge lamp.

8. The multilevel electrodeless luminaire of claim 6 wherein the high output lamp is an LED lamp.

9. A multilevel electrodeless luminaire comprising:
a power supply;
a first induction coil for supplying electromagnetic radiation to a gaseous mixture enclosed within a first vessel;
a first driver for supplying an oscillating electrical signal to said first induction coil so as to create a plasma of circulating charged particles within said vessel, said driver comprising a power supply and a power amplifier;
a second induction coil for supplying electromagnetic radiation to a gaseous mixture enclosed within a second vessel; and
a second driver for supplying an oscillating electrical signal to said second induction coil so as to create a plasma of circulating charged particles within said vessel, said second driver comprising a power supply and a power amplifier; and
an occupancy sensing means operative tb stop power from being supplied to said second driver if ambient light is greater than a daylight setpoint.

10. The multilevel electrodeless luminaire of claim 9 wherein the occupancy sensing means is motion detector.

11. The multilevel electrodeless luminaire of claim 9 wherein the occupancy sensing means stops load from turning on the if ambient light is greater than the daylight setpoint.

12. The multilevel electrodeless luminaire of claim 9 wherein the occupancy sensing means detects motion via super high-frequency electromagnetic waves and the Doppler principle.

13. The multilevel electrodeless luminaire of claim 12 wherein the occupancy sensing means is omnidirectional.

14. The multilevel electrodeless luminaire of claim 9 wherein the low output lamp is an electrodeless discharge lamp.

15. The multilevel electrodeless luminaire of claim 14 wherein the high output lamp is an electrodeless discharge lamp.

16. The multilevel electrodeless luminaire of claim 14 wherein the high output lamp is an LED lamp.

17. A method of constructing a multilevel electrodeless luminaire comprising:
(a) providing a luminaire housing, a low output ballast, at least one high output ballast, a low wattage lamp, at least one high wattage lamp, and an occupancy sensor,
(b) connecting said low output ballast to said low wattage lamp,
(c) connecting said high output ballast to said high wattage lamp and said occupancy sensor.

18. The method of claim 17 wherein said low wattage lamp is an electrodeless discharge lamp.

19. The method of claim 18 wherein said high wattage lamp is an electrodeless discharge lamp.

20. The method of claim 18 wherein said high wattage lamp is an LED lamp.
